(19) United States
(12) Patent Application Publication
(10) Pub. No.: US 2026/0235098 A1
(43) Pub. Date: Aug. 13, 2026

(54) FUEL PUMP DIAGNOSTIC APPARATUSES, METHODS, AND SYSTEMS

(71) Applicant: Cummins Inc., Columbus, IN (US)

(72) Inventors: Michael R. Tidwell, Bloomington, IN (US); Abhishek Javvaji, Fitchburg, WI (US); Sarah E. Gnau, Lexington, KY (US)

(21) Appl. No.: 19/156,433

(22) PCT Filed: Feb. 13, 2024
(86) PCT No.: PCT/US2024/015457

§ 371 Date: Aug. 14, 2025

Related U.S. Application Data
(60) Provisional application No. 63/485,546, filed on Feb. 17, 2023.

(51) Int. Cl. F02M 65/00; F02D 41/22; F02D 41/30; G07C 5/00; G07C 5/08

(52) U.S. Cl. CPC F02M 65/003; F02D 41/22; F02D 41/3076; G07C 5/008; G07C 5/0808; F02D 2041/224

(57) ABSTRACT

A method of testing a fuel pump of an engine includes cranking the engine with a starter motor, inhibiting fuel injection to the engine concurrent with the cranking and opening an inlet metering valve to provide fuel to the fuel pump concurrent with the cranking and the inhibiting. The method includes measuring fuel pressure at or downstream of an outlet of the pump concurrent with the cranking, the inhibiting, and the opening, and diagnosing a condition of the pump in response to the measuring.

### CROSS-REFERENCE

The present disclosure claims priority to and the benefit of U.S. Application No. 63/485,546 filed Feb. 17, 2023, and the same is hereby incorporated by reference.

### BACKGROUND

The present application relates to diagnostic for fuel pumps and related apparatuses, methods, and systems. There remains a significant unmet need for the unique apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and method of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

One embodiment is a unique system for testing or diagnosing a fuel pump. Another embodiment is a unique method for testing or diagnosing a fuel pump. Another embodiment is a unique apparatus for testing or diagnosing a fuel pump. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example system.

FIG. 2 is a schematic diagram illustrating certain aspects of an example method.

FIGS. 3-5 are graphs illustrating certain aspects of example operations of an example methods and systems.

### DETAILED DESCRIPTION OF EXAMPLE EMBODIMENTS

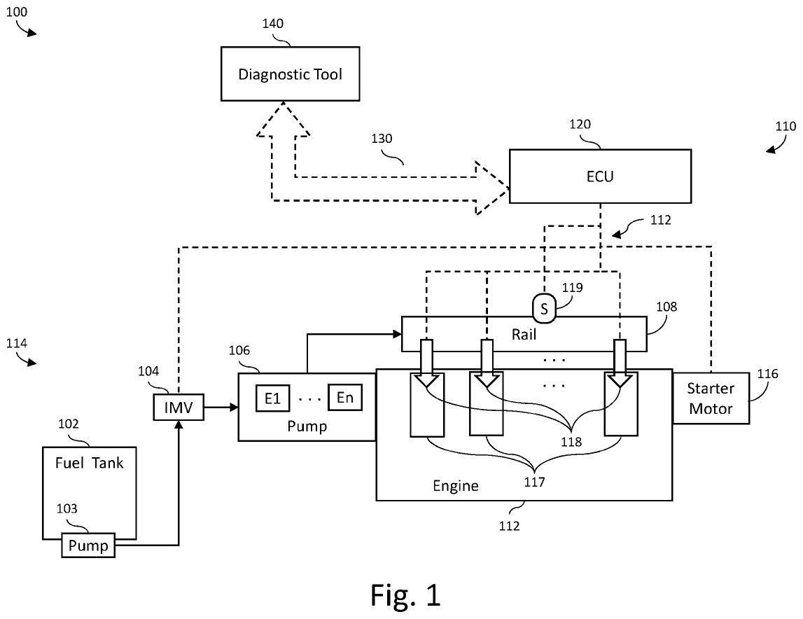

With reference to FIG. 1, there is illustrated a system 100 including a diagnostic tool 140 and an engine system 110. The diagnostic tool 140 may be selectably operatively coupled with and in operative communication with an electronic control unit (ECU) 120 of engine system 110 via one or more communication links 130. Diagnostic tool 140 and communication links 130 may be provided in a number of forms.

In some embodiments, diagnostic tool 140 may be implemented and executed in connection with one or more computing devices present at the location of engine system 110 (e.g., at a service bay or another point-of-service at which engine system 110 is located). In such embodiments, communication links 130 may include one more physical connections with engine system 110, for example, via an OBD II interface, a J1939 interface, or various other interfaces.

In some embodiments, diagnostic tool 140 may be implemented and executed in connection with one or more computing devices located remotely from engine system 110 and communication links 130 may include one more networks including wired and/or wireless networks or network components configured and operable to provide communication between diagnostic tool 140 and ECU 120 of engine system 110. Some such embodiments may include one or more computing devices located remotely from engine system 110 and in communication with ECU 120 of engine system 110 via a telematics system. Some such embodiments may include a combination of one or more computing devices located remotely from engine system 110 and one or more computing devices present at the location of engine system 110 (e.g., at a service bay or another point-of-service at which engine system 110 is located).

While diagnostic tool 140 is depicted in FIG. 1 as external to engine system 110, on some embodiments, diagnostic tool 140 may be embedded or otherwise provide in engine system 110. In some such embodiments, diagnostic tool 140 may be embedded or otherwise provide in and executed by ECU 120 and/or other components of an electronic control system (ECS) of engine system 110. In some such embodiments communication links 130 may include one or more intra-ECU or intra ECS communication channels or may be omitted in instances where a communication link is not required.

Engine system 110 further includes an engine 112, a starter motor 116 operatively coupled with engine 112 and ECU 120, and a fueling system 114 operatively coupled with engine 112 and ECU 120. In the illustrated embodiment engine 112 is a direct-injection, reciprocating piston-type internal combustion engine configured and operable to combust fuel injected by one or more fuel injectors 118 directly into one respective ones of a plurality of combustion cylinders 117. It shall be appreciated that engine 112 may be configured and provided in various forms including various numbers of combustion chambers 117 and various numbers of fuel injectors 118.

In the illustrated embodiment, fueling system 114 is configured and provided as a high-pressure common-rail (HPCR) fueling system. In other embodiments, fueling system may be provided in a various other forms as will occur to one of skill in the art with the benefit and insight of the present disclosure. Fueling system 114 includes fuel rail 108 which receives pressurized fuel from a high-pressure fuel pump 106 and provides pressurized fuel to fuel injectors 118. In the illustrated embodiment, fuel pump 106 is provided and configured as a high pressure fuel pump that includes one or more pump elements (E1 . . . En) such as piston-in-cylinder-type pump elements configured to pressurize fuel received by fuel pump 106.

An inlet metering valve (IMV) 104 is provided at or upstream from an inlet to fuel pump 106 and is operatively coupled with and controllable by ECU 120 to meter or regulate flow of fuel into fuel pump 106. It shall be appreciated that IMV 104 may also be referred to as a volume control valve, flow control valve, magnetic proportional valve, or various other terms of art. IMV 104 is configured and operable to received fuel pumped from fuel tank 102 by pump 103 which may be configured and provided as a low pressure fuel pump.

ECU 120 is in operative communication with and configured to control IMV 104 between a fully closed position which permits minimum fuel flow to fuel pump 106 (e.g., substantially no fuel flow) and a fully open position which permits maximum fuel flow to fuel pump 106. IMV 104 and fuel pump 106 may be configured such that the maximum fuel flow provided by IMV 104 to fuel pump 106 is greater than the pumping volume of fuel pump 106 under some operating conditions. For example, IMV 104 may be configured such that it can overfill the fuel pump 106 a low engine speeds or during engine cranking. At higher engine speeds, the IMV 104 may not meet the full capacity of the high pressure pump in some embodiments and instances. ECU 120 is also in operative communication with and configured to receive pressure measurements from pressure sensor 119 which is configured to sense pressure of fuel in fuel rail 108. ECU 120 is further in operative communication with and configured to control operation of fuel injectors 118 to inject fuel in to combustion cylinders 117 of engine 112. ECU 120 is also in operative communication with and configured to provide control signals to selectably operate starter motor 116 to crank engine 112. Control signals to operate starter motor 116 to crank engine 112 may additionally or alternatively be provided in response to a technician commanding or triggering engaging or operation of starter motor 116. In some embodiments an automated starter may be present and may also be controllable via a body control module and may include a push button for manual starting.

ECU 120 is an example of a component of an ECS configured and operable to execute operating logic that defines various control, diagnostic, management, and/or regulation functions. For example, the non-transitory memory medium may be configured with instructions executable by the processor to perform a number of acts, evaluations, or operations including those described herein. The operating logic of ECU 120 or other ECS components may be in the form of dedicated hardware, such as a hardwired state machine, analog calculating machine, programming instructions, and/or a different form as would occur to those skilled in the art.

While ECU 120 is depicted as single unit in the illustrated example, it shall be appreciated that one or more processor, one or more non-transitory memory medium, and related components may be provided as or distributed across or among multiple units or physical packages. For example, one or more processors, such as programmable microprocessors or microcontrollers of a solid-state, integrated circuit type which may be provided in one or more control units and can be implemented in any of a number of ways that combine or distribute the control function across one or more control units in various manners. Other components or subsystems of ECU 120 and/or its associated ECS may also be so configured or provided.

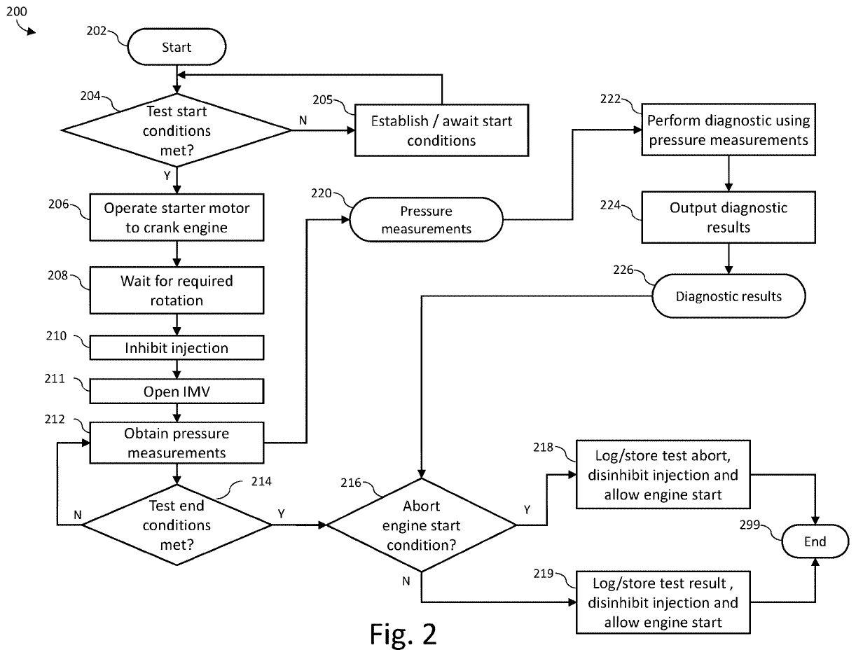

With reference to FIG. 2, there is illustrated an example method 200 which may be implemented and performed, in whole or in part, in connection with a system such as system 100. Method 200 is one example of a method according to the present disclosure for performing a diagnostic or test of a fuel pump such as fuel pump 106.

Method 200 begins at start operation 202 and proceeds to conditional 204 which tests whether one or more test start conditions is or are satisfied. The one or more test start conditions may include a number of conditions which may vary according to the particular system with which method 200 is performed.

The one or more test start conditions may include fuel system conditions which may be established or selected to provide conditions desirable for testing a fuel pump such as fuel pump 106. Such conditions may include, for example, an valve such as IMV 104 being closed, a pressure such as a fuel pressure of fuel rail 108 being below a threshold value, or other conditions indicative of or suitable as proxies for a depressurized condition of high pressure portions of a fueling system such as fueling system 114.

In some embodiments, the one or more test start conditions may include an initiation of a test by a technician and/or a diagnostic tool such as diagnostic tool 140. Such embodiments may include, for example, embodiments in which method 200 is performed during a diagnostic, service, or repair event.

In some embodiments, the one or more test start conditions may include a key-on condition and/or one or more engine start conditions. Such embodiments may include, for example, embodiments in which method 200 is performed each time an engine such as engine 112 is started during operation or on a regular or periodic basis when an engine is started or in combination with events such as the detection of error, failure, or fault conditions potentially related to a fuel pump.

If conditional 204 evaluates negative, method 200 proceeds to operation 205 at which method 200 establishes and/or awaits the establishment of the start conditions evaluated by conditional 204. If conditional 204 evaluates affirmative, method 200 proceeds to operation 206 which operates a starter motor to crank an engine. Operation 206 may include an ECU requesting starter motor engagement via automated vehicle systems and/or may include a request or prompt for a technician to manually engage a starter motor. The starter motor may be starter motor 116 of engine system 110 or another starter motor of another system. From operation 206, method 200 proceeds operation 208 which waits for and/or monitors for and required engine rotation condition. The required engine rotation condition may include a minimum engine speed (rpm) and/or a minimum amount of angular rotation or time after engagement of a started motor such as starter motor 116 to crank an engine such as engine 112.

From operation 208, method 200 proceeds to operation 210 which inhibits injection by fuel injectors such as fuel injectors 118, for example, by inhibiting injection control signals or otherwise controlling the injectors to perform no injection.

From operation 210, method 200 proceeds to operation 211 which and opens an IMV such as IMV 104. Operation 211 may open an IMV to permit a desired amount or rate of fuel flow to a pump such as fuel pump 106, for example, by opening an IMV to permit maximum fuel flow to a pump such as fuel pump 106. The desired amount or rate of fuel flow to the pump may be provided by opening the IMV to a maximally open position or to at least a threshold position, for example, a position at which the amount or rate of fuel flow is above a threshold value (e.g., above the pumping capacity of the pump).

From operation 211, method 200 proceeds to operation 212 which obtains one or more pressure measurements 220 indicative of a fuel pressure of a high-pressure portion of a fueling system such as fueling system 114. The one or more pressure measurements 220 may be obtained by receiving values from a pressure sensor such as pressure sensor 119 indicative of pressure of fuel in a fuel rail such as fuel rail 108.

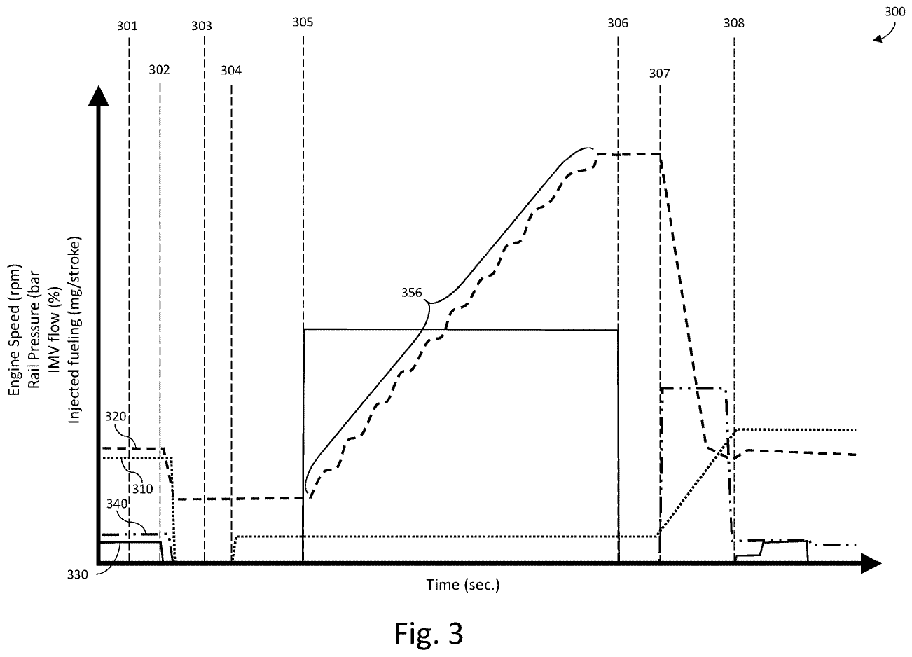

The one or more pressure measurements 220 may be provided to operation 222, which performs one or more diagnostics all using the one or more pressure measurements 220. The one or more diagnostics may include a number of diagnostics such as those described in connection with FIGS. 3-5.

From operation 222, method 200 proceeds to operation 224 which outputs one or more diagnostic results 226 of the one or more diagnostics performed by operation 222. Outputting the one or more diagnostic results 226 may include communicating, displaying, transmitting, storing, or otherwise outputting the one or more diagnostic results 226.

From operation 212, method 200 proceeds to conditional 214 which evaluates whether one or more test end conditions are met. The one or more test end conditions may include, for example, a rail pressure above a threshold, a predetermined amount of crank angle rotation, a test duration above a threshold, a number of pressure measurements above a threshold or other metric, a rail pressure above a threshold, or various combinations thereof. If conditional 214 evaluates negative, method 200 proceeds to operation 212.

If conditional 214 evaluates affirmative, method 200 proceeds to conditional 216 which evaluates whether a test abort condition is true. Conditional 216 may evaluate whether a test abort condition is true in whole or in part in response to diagnostic results 226 or the absence thereof. If conditional 216 evaluates affirmative, method 200 proceeds to operation 218 which logs or stores a test abort condition and information associated therewith (e.g., an indication or reason why the test was aborted), disinhibits fuel injection, removes any other test overrides, and allows the engine start operation to continue uninhibited by method 200. If conditional 216 evaluates negative, method 200 proceeds operation 219 which logs or stores test results such as diagnostic results 226 or other operation associated therewith (e.g., test date and time and/or other diagnostic information associated with the test), disinhibits fuel injection, removes any other test overrides, and allows the engine start operation to continue uninhibited by method 200. From operation 218 or operation 219, method 200 proceeds to end operation 299 and may be subsequently called or repeated.

With reference to FIG. 3, there is illustrated a graph 300 depicting several operational parameters of a system such as system 100 in connection with a diagnostic or test such as the diagnostic or test of method 200. Graph 300 depicts curves 310, 320, 330, and 340. Curve 310 depicts engine speed (rpm) on the vertical axis as a function of time(s) on the horizontal axis of graph 300 which may be, for example, the operating speed of engine 112. Curve 320 depicts fuel rail pressure (Bar) on the vertical axis as a function of time(s) on the horizontal axis of graph 300 which may be, for example, the pressure in fuel rail 108 which may be measured, for example, by pressure sensor 119. Curve 330 depicts IMV flow (%) on the vertical axis as a function of time(s) on the horizontal axis of graph 300 which may be for example, the percent of maximum flow amount or flow rate or percent of maximum open position of IMV 104. Curve 340 depicts injected fuel (mg/stroke) on the vertical axis as a function of time(s) on the horizontal axis of graph 300 which may be, for example, amount of fuel injected by fuel injectors 118 for each respective piston stroke. The operations of the underlying system and method of graph 300 may be further understood relative to times 301, 302, 303, 304, 305, 306, 307, and 308 which are indicated with dashed vertical lines.

Prior to time 301, curve 310 shows the engine of the underlying system operating at an idle speed, curve 320 shows the rail pressure of the underlying system operating at an idling pressure, curve 330 shows an IMV flow operating at a percent fuel flow for engine idle, and curve 340 shows an injected fueling at an idle amount. At time 301 a fuel pump test is triggered, for example, by a diagnostic tool such as diagnostic tool 140 in operative communication with an engine such as engine 112.

At time 302, an ECU such as ECU 120 controls an IMV such as IMV 104 to close as indicated by the drop in curve 330. Thereafter curves 320, 310, and 340 also drop as the fuel rail depressurizes, the engine stops, and fuel injection stops. It shall be appreciated that one or more of the foregoing conditions or control states may be utilized as criteria for continuing with or performing subsequent operations of a test or diagnostic of a fuel pump such as fuel pump 106, for example, as the conditions utilized by conditional 204 of method 200.

At time 303, an ECU such as ECU 120 disables operation of fuel injectors such as fuel injectors 118. At time 304, a starter motor such as starter motor 116 is engaged to crank an engine such as engine 112 and curve 310 thereafter increases to an engine cranking speed. At time 305, an ECU such as ECU 120 opens an IMV such as IMV 104 to a maximum open position or other desired position and curve 320 thereafter increases over region 356 as rail pressure increases due to operation of the pump with injection inhibited and engine cranking occurring. One or more pressure measurements, such as pressure measurements 220 may be taken during operation in region 356.

At time 305, an ECU such as ECU 120 opens an IMV such as IMV 104 to a maximum open position or other desired position and curve 320 thereafter increases over region 356 as rail pressure increases due to operation of the pump with injection inhibited and engine cranking occurring. One or more pressure measurements, such as pressure measurements 220 may be taken during operation in region 356.

At time 306, and the ECU closes the IMV. At time 307, the test or diagnostic method disinhibits fuel injection and may also remove any other overrides or inhibits associated with the test or diagnostic. Thereafter, curve 330 increases indicating the resumption of engine starting fueling and curve 310 increases indicating as engine speed increased during engine start, At time 308, the engine has started and an indication that the test or diagnostic is complete may be provided.

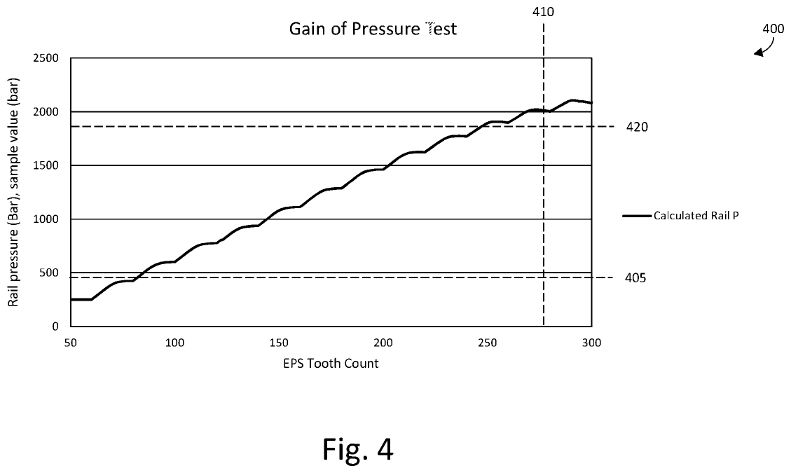

With reference to FIG. 4, there is illustrated a graph 400 depicting certain aspects of an example gain of pressure test which may be performed as a diagnostic in connection with operation 222 of method 200. The gain of pressure test may be initiated once engine speed has reached a predetermined or calibratible threshold 405, and rationality or proper operation is established for an engine position sensor (EPS) (also referred to as a crank angle sensor), and an IMV has opened. After initiation, the gain of pressure test may being logging rail pressure and counting engine revolutions. If the number of engine revolutions has reached a predetermined or calibratible number 410, the gain of pressure test may close the IMV and evaluate the gain of pressure since initiation. If rail pressure has not increased to or above a predetermined or calibratible threshold 420, the gain of pressure test may log a fail condition of the pump. If, as shown in FIG. 4, rail pressure has increased to or above the predetermined or calibratible threshold 420, the gain of pressure test may log a pass condition of the pump. If at any time during the gain of pressure test, rail pressure rises above a calibrated threshold, the gain of pressure test may be aborted.

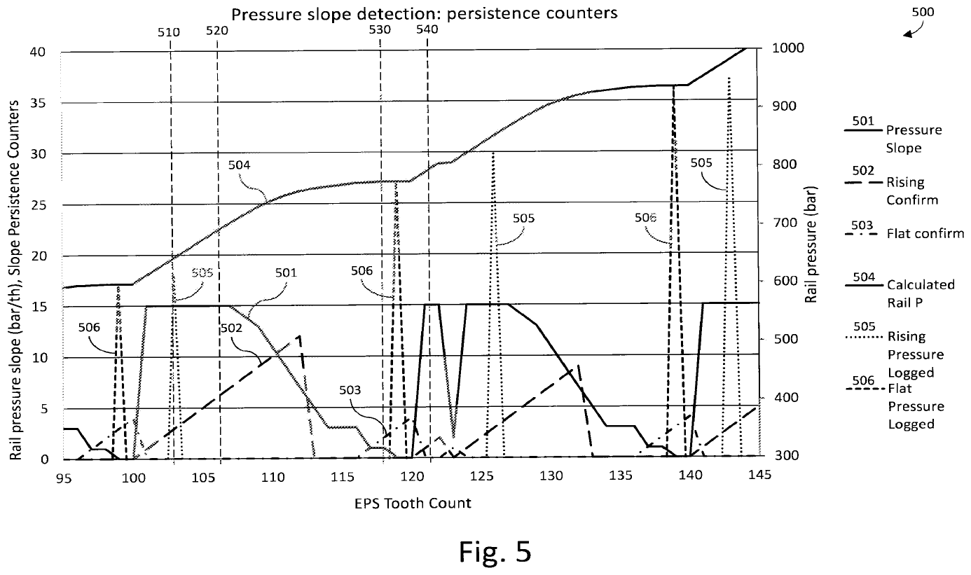

With reference to FIG. 5, there is illustrated a graph 500 depicting certain aspects of a pumping event identification methodology which may be utilized in connection with a number of pumping event diagnostic example in connection with operation 222 of method 200. Graph 500 depicts curve 504 which indicates calculated rail pressure as a function of engine position (EPS tooth count), curve 501 which indicates the slope of curve 504, curve 502 which indicates a rising slope confirm signal, curve 503 which indicates a flat confirm signal, pulses 505 which indicate rising pressure measurement or log events, and pulses 506 which indicate flat pressure measurement or log events.

It shall be appreciated that decoding a signal using a derivative analysis allows for individual pumping elements to be recognized. The angular duration of pumping is an indication of the stroke of a pumping element and/or the amount of fill in the pumping element. One common pump failure occurs when the plunger of an element seizes and doesn't move. Pressure rise can also be influenced by factors outside of the pump, especially leakage from the high pressure systems, for example, due to injectors leaking to a fuel drain. Obtaining and utilizing information of both pressure rise per pumping and the angular duration of pumping allows for better isolation to pump failures. This can help preventing false detection of pump failures due to reasons unrelated to a pump or its operation, for example in the case of high pressure leakage. Accordingly, combinations of the pressure rise and duration data can be used for enhanced diagnostics which can isolate the nature of the pump failure. It shall be further appreciated that rising confirm curve 502 and flat confirm curve 503 may be utilized to establish or provide confirmation conditions for evaluation of curve 501 effective to mitigate or reject signal noise and prevent false transitions due to random signal noise.

As illustrated by curve 503, a pumping event is characterized by a period of rising pressure with flat (or mostly-flat) pressure before and after it. The present methodology allow such pressure rises to be identified and measured. The pressure slope indicated by curve 501 may be evaluated relative to a predetermined or calibratible thresholds to identify two modes in the crank-angle domain (also referred to as an EPS-tooth domain): rising pressure (e.g., when curve 501 above a rising threshold) and flat pressure (e.g., when curve 501 below the flat pressure threshold).

A minimum crank-angle domain period of a state transition for rising-to-flat and for flat-to-rising may be established as a predetermined or calibratible value. This minimum period may be utilized to disregard or filter out aberrations during which a pressure transition does not persist for longer than the minimum threshold. For example, at time 510 a rising pressure slope begins to be detected as the value of curve 501 exceeds a rising pressure slope threshold. Thereafter a rising pressure slope associated with a pulse 505 is logged. If, as illustrated in FIG. 5 the rising pressure slope continues to be detected as if time 520, the rising pressure slope is considered validated and may be retained.

At time 530 a flat pressure slope begins to be detected as the value of curve 501 falls below a flat pressure slope threshold. Thereafter a flat pressure slope 506 is logged. If, as illustrated in FIG. 5 the flat pressure slope continues to be detected as if time 540, the flat pressure slope is considered validated and may be retained.

A number of values may be stored utilized in logging measurements according to the methodology of FIG. 5 including, for example, a start-of-pumping vector, an end-of-pumping vector, start of pumping pressure vector, and end of pumping pressure vector. Once pressure has reached a calibrated pressure and the engine has reached a calibrated speed, the beginning of pressure rise tooth count and pressure and the end of pressure rise tooth count and pressure may be recorded in the respective vectors. If a rising edge is not detected within a calibratible tooth count of when the previous pumping cylinder element began start of pumping, an entry in the start-of-pumping and end-of-pumping vectors may be skipped and left at an initialized value. Pumping duration may be calculated for each valid pumping event (end tooth-start tooth, allowing for wrap around) and stored in a pumping duration vector (using an initialized value to mark invalid pumping events). Pressure rise may be calculated for each valid pumping event in a similar way. Pressure and tooth count events may be assigned to pumping elements sequentially, given a predetermined or calibratible number of pumping elements. The first pumping event may be defined as a first pumping element, regardless of actual pump configuration. If no rising edge is ever detected on an individual pumping cylinder element during the calibration phase, the remaining processing may be skipped and a non-pumping event failure may be recorded.

Once either the rail pressure reaches a calibrated threshold or a crank timer expires, the test should end and the IMV should command zero flow. The mean pressure rise for each pumping cylinder element and the pressure rise duration (in teeth) for each pumping cylinder element is calculated. If the difference in mean pressure rise among pumping cylinder elements or the difference in pressure rise duration among pumping cylinder elements is larger than calibrated thresholds (two thresholds), a fault condition is detected. If the standard deviation of pressures associated with an individual pumping cylinder elements exceeds a calibrated threshold, a fault condition is detected. If a calibratible number of pressure steps on a single pumping cylinder element are below a calibratible ‘zero pumping’ threshold or identified as invalid, a non-pumping event failure is detected.

It shall be appreciated that the methodology described in connection with FIG. 5 is one example of a methodology for identifying pressure increases corresponding to individual pumping cylinder elements. Once such information is identified a number analytics and diagnostics may be performed including, for example, comparing or evaluating average pressure increases for multiple pumping elements across multiple pumping events, and comparing or evaluating multiple pressure increases for multiple pumping events for a single pumping element. A number of statistics including variances, weighted averages, and other statics as will occur to one of skill in the art may also be utilized. Furthermore, as noted above such analytics and diagnostics may be performed by or in connection with operation 222 of method 200.

As illustrated by this detailed description, the present disclosure contemplates multiple and various embodiments, including, without limitation, the following example embodiments. A first example embodiment is a method of testing a fuel pump of an engine, the method comprising: cranking the engine with a starter motor; inhibiting fuel injection to the engine concurrent with the cranking; opening an inlet metering valve to provide fuel to the fuel pump concurrent with the cranking and the inhibiting; measuring fuel pressure at or downstream of an outlet of the pump concurrent with the cranking, the inhibiting, and the opening; diagnosing a condition of the pump in response to the measuring; and terminating the cranking and one of (a) disinhibiting fuel injection and allowing the engine to start, and (b) and allowing the engine to stop.

A second example embodiment includes the features of the first example embodiment, wherein the diagnosing comprises performing a gain of pressure test to evaluate whether a minimum net fuel pressure increase is achieved during a test duration.

A third example embodiment includes the features of the first example embodiment, wherein the diagnosing comprises performing a pressure test to evaluate one or more individual pumping events associated with a respective pumping element of the fuel pump.

A fourth example embodiment includes the features of any one of the first through third example embodiments, wherein the method is performed during an out-of-mission service event.

A fifth example embodiment includes the features of the fourth example embodiment, wherein the method is performed to test a newly installed fuel pump.

A sixth example embodiment includes the features of any one of the first through third example embodiments, wherein the method is performed during an in-mission engine start event.

A seventh example embodiment is a system comprising: an engine system including a fueling system including a fuel pump, and a starter motor operatively coupled with the engine, and an electronic control unit (ECU) configured to perform the operations of: cranking the engine with a starter motor; inhibiting fuel injection to the engine concurrent with the cranking; opening an inlet metering valve to provide fuel to the fuel pump concurrent with the cranking and the inhibiting; measuring fuel pressure at or downstream of an outlet of the pump concurrent with the cranking, the inhibiting, and the opening; diagnosing a condition of the pump in response to the measuring; and terminating the cranking and one of (a) disinhibiting fuel injection and allowing the engine to start, and (b) and allowing the engine to stop.

An eighth example embodiment includes the features of the seventh example embodiment, wherein the ECU being configured to perform the operation of diagnosing comprises ECU being configured to perform a gain of pressure test to evaluate whether a minimum net fuel pressure increase is achieved during a test duration.

A ninth example embodiment includes the features of the seventh example embodiment, wherein the ECU being configured to operation of diagnosing comprises ECU being configured to perform a pressure test to evaluate one or more individual pumping events associated with a respective pumping element of the fuel pump.

A tenth example embodiment includes the features of any one of the seventh through ninth example embodiments, wherein the ECU is operatively coupled with an external diagnostic tool.

An eleventh example embodiment includes the features of any one of the seventh through ninth example embodiments, wherein the fuel system is a high-pressure, common-rail fuel system and the pump is a high-pressure pump.

A twelfth example embodiment includes the features of any one of the seventh through ninth example embodiments and includes a fuel rail configured to receive pressurized fuel from the pump and a pressure sensor configured to measure fuel pressure of the fuel rail.

A thirteenth example embodiment is an apparatus for testing a fuel pump of an engine, the apparatus comprising: a non-transitory memory medium configured to store instructions executable by a processor to perform the acts of: cranking the engine with a starter motor; inhibiting fuel injection to the engine concurrent with the cranking; opening an inlet metering valve to provide fuel to the fuel pump concurrent with the cranking and the inhibiting; measuring fuel pressure at or downstream of an outlet of the pump concurrent with the cranking, the inhibiting, and the opening; diagnosing a condition of the pump in response to the measuring; and terminating the cranking and one of (a) disinhibiting fuel injection and allowing the engine to start, and (b) and allowing the engine to stop.

A fourteenth example embodiment includes the features of the thirteenth example embodiment, wherein the act of diagnosing comprises performing a gain of pressure test to evaluate whether a minimum net fuel pressure increase is achieved during a test duration.

A fifteenth example embodiment includes the features of the thirteenth example embodiment, wherein the act of diagnosing comprises performing a pressure test to evaluate one or more individual pumping events associated with a respective pumping element of the fuel pump.

A sixteenth example embodiment includes the features of any one of the thirteenth through fifteenth example embodiments, wherein the instructions are configured to operate during an out-of-mission service event.

A seventeenth example embodiment includes the features of the sixteenth example embodiment, wherein the instructions are configured to test a newly installed fuel pump.

An eighteenth example embodiment includes the features of any one of the thirteenth through fifteenth example embodiments, wherein the instructions are configured to operate during an in-mission engine start event.

A nineteenth example embodiment includes the features of any one of the thirteenth through fifteenth example embodiments, wherein the apparatus comprises an on-engine electronic control unit (ECU).

An twentieth example embodiment includes the features of any one of the thirteenth through fifteenth example embodiments, wherein the apparatus comprises apparatus comprises an on-engine electronic control unit (ECU) in combination with a diagnostic tool external to the ECU.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of testing a fuel pump of an engine, the method comprising:
cranking the engine with a starter motor;
inhibiting fuel injection to the engine concurrent with the cranking;
opening an inlet metering valve to provide fuel to the fuel pump concurrent with the cranking and the inhibiting;
measuring fuel pressure at or downstream of an outlet of the pump concurrent with the cranking, the inhibiting, and the opening;
diagnosing a condition of the pump in response to the measuring; and
terminating the cranking and one of (a) disinhibiting fuel injection and allowing the engine to start, and (b) and allowing the engine to stop.

2. The method of claim 1, wherein the diagnosing comprises performing a gain of pressure test to evaluate whether a minimum net fuel pressure increase is achieved during a test duration.

3. The method of claim 1, wherein the diagnosing comprises performing a pressure test to evaluate one or more individual pumping events associated with a respective pumping element of the fuel pump.

4. The method of claim 1, wherein the method is performed during an out-of-mission service event.

5. The method of claim 4, wherein the method is performed to test a newly installed fuel pump.

6. The method of claim 1, wherein the method is performed during an in-mission engine start event.

7. A system comprising:
an engine system including a fueling system including a fuel pump, and a starter motor operatively coupled with the engine, and an electronic control unit (ECU) configured to perform the operations of:
cranking the engine with a starter motor;
inhibiting fuel injection to the engine concurrent with the cranking;
opening an inlet metering valve to provide fuel to the fuel pump concurrent with the cranking and the inhibiting;
measuring fuel pressure at or downstream of an outlet of the pump concurrent with the cranking, the inhibiting, and the opening;
diagnosing a condition of the pump in response to the measuring; and
terminating the cranking and one of (a) disinhibiting fuel injection and allowing the engine to start, and (b) and allowing the engine to stop.

8. The system of claim 7, wherein the ECU being configured to perform the operation of diagnosing comprises ECU being configured to perform a gain of pressure test to evaluate whether a minimum net fuel pressure increase is achieved during a test duration.

9. The system of claim 7, wherein the ECU being configured to operation of diagnosing comprises ECU being configured to perform a pressure test to evaluate one or more individual pumping events associated with a respective pumping element of the fuel pump.

10. The system of claim 7, wherein the ECU is operatively coupled with an external diagnostic tool.

11. The system of claim 7, wherein the fuel system is a high-pressure, common-rail fuel system and the pump is a high-pressure pump.

12. The system of claim 7, including a fuel rail configured to receive pressurized fuel from the pump and a pressure sensor configured to measure fuel pressure of the fuel rail.

13. An apparatus for testing a fuel pump of an engine, the apparatus comprising:
a non-transitory memory medium configured to store instructions executable by a processor to perform the acts of:
cranking the engine with a starter motor;
inhibiting fuel injection to the engine concurrent with the cranking;
opening an inlet metering valve to provide fuel to the fuel pump concurrent with the cranking and the inhibiting;
measuring fuel pressure at or downstream of an outlet of the pump concurrent with the cranking, the inhibiting, and the opening;
diagnosing a condition of the pump in response to the measuring; and
terminating the cranking and one of (a) disinhibiting fuel injection and allowing the engine to start, and (b) and allowing the engine to stop.

14. The apparatus of claim 13, wherein the act of diagnosing comprises performing a gain of pressure test to evaluate whether a minimum net fuel pressure increase is achieved during a test duration.

15. The apparatus of claim 13, wherein the act of diagnosing comprises performing a pressure test to evaluate one or more individual pumping events associated with a respective pumping element of the fuel pump.

16. The apparatus of claim 13, wherein the instructions are configured to operate during an out-of-mission service event.

17. The apparatus of claim 16, wherein the instructions are configured to test a newly installed fuel pump.

18. The apparatus of claim 13, wherein the instructions are configured to operate during an in-mission engine start event.

19. The apparatus of claim 13, wherein the apparatus comprises an on-engine electronic control unit (ECU).

20. The apparatus of claim 13, wherein the apparatus comprises apparatus comprises an on-engine electronic control unit (ECU) in combination with a diagnostic tool external to the ECU.
